(19) United States
(12) Patent Application Publication
(10) Pub. No.: US 2025/0069090 A1
(43) Pub. Date: Feb. 27, 2025

(54) CARBON CREDIT REGISTRATION SYSTEM AND METHOD

(71) Applicant: Smart Approach CO., LTD., Zhubei City (TW)

(72) Inventors: Hsin-Lung LIN, Zhubei City (TW); You Long LAI, Zhubei City (TW)

(21) Appl. No.: 18/812,232

(22) Filed: Aug. 22, 2024

Related U.S. Application Data
(60) Provisional application No. 63/534,410, filed on Aug. 24, 2023.

(30) Foreign Application Priority Data
Jun. 26, 2024 (TW) 113123793

(51) Int. Cl. G06Q 30/018

(52) U.S. Cl. CPC G06Q 30/018

(57) ABSTRACT

A carbon credit registration method includes the following steps: a reading device reads an electronic tag disposed on an object to obtain an identification code, where the identification code corresponds to a company; a communication device electrically connected to the reading device sends the identification code to a cloud host; the cloud host searches a database based on the identification code to obtain a corresponding stored record; and when it is confirmed that the stored record has a processing proof, the cloud host sends an authorization signal to the communication device, sets a used mark on the stored record in the database, and registers a carbon credit feedback value for the company in the storage record, where the carbon credit feedback value is related to the type of the object.

### CROSS-REFERENCE TO RELATED APPLICATIONS

This application claims priority under 35 U.S.C. § 119(a) of U.S. patent application Ser. No. 63/534,410, filed Aug. 24, 2023, and of Taiwan Patent Application No. 113123793, filed Jun. 26, 2024, the entire contents of which are hereby incorporated by reference.

### BACKGROUND

### 1. Technical Field

The present disclosure relates to the use of environmentally friendly objects and their carbon credit feedback methods, particularly to a carbon credit registration system and method.

### 2. Related Art

In order to achieve global carbon reduction goals, governments typically implement carbon emission limits and carbon market trading. Carbon market trading is a method to reduce carbon emissions through the buying and selling of carbon credits. This mechanism incentivizes companies to adopt emission reduction measures while also providing economic rewards to those companies that actually achieve emission reduction targets. However, carbon market trading requires accurate carbon inventory data to support it, ensuring the accuracy and fairness of transactions. Conducting a carbon inventory is a crucial part of a company's carbon management. Through the assessment and analysis of carbon emission sources, companies can determine their carbon footprint, understand the main sources of carbon emissions, and identify hotspot areas. This not only helps companies develop more effective emission reduction strategies but also optimizes production processes, reducing energy consumption and waste. Meanwhile, carbon inventory provides accurate data for carbon market trading, ensuring the reliability and traceability of transactions.

On the other hand, the carbon emissions caused by various disposable products have a significant impact on the environment. Although these disposable products can be recycled and reused by consumers, there is still a lack of a carbon footprint tracking mechanism for the recycling process.

### SUMMARY

In light of the above descriptions, the present disclosure proposes a carbon credit registration system and method to solve the aforementioned problems.

According to one or more embodiment of the present disclosure, a carbon credit registration method includes: reading, by a reading device, an electronic tag disposed on an object to obtain an identification code, wherein the identification code corresponds to a company; sending, by a communication device electrically connected to the reading device, the identification code to a cloud host; searching, by the cloud host, a database according to the identification code to obtain a stored record corresponding to the identification code; sending, by the cloud host, an authorization signal to the communication device and setting a used mark on the stored record in the database when the stored record is confirmed to have a processing proof; and registering, by the cloud host, a carbon credit feedback value of the company in the stored record, wherein the carbon credit feedback value is associated with a type of the object.

According to one or more embodiment of the present disclosure, a carbon credit registration system includes a reading device, a communication device and a cloud host. The reading device is configured to read an electronic tag disposed on an object to obtain an identification code. The identification code corresponds to a company. The communication device is electrically connected to the reading device. The communication device is configured to send the identification code and receive an authorization signal. The cloud host is communicably connected to the communication device. The cloud host is configured to search a database according to the identification code to obtain a stored record corresponding to the identification code. When the stored record is confirmed to have a processing proof, the cloud host is configured to send the authorization signal to the communication device, set a used mark on the stored record in the database, and register a carbon credit feedback value of the company in the stored record. The carbon credit feedback value is associated with a type of object.

According to one or more embodiment of the present disclosure, a carbon credit registration method includes: reading, by a reading device, an electronic tag disposed on an object to obtain an identification code, wherein the identification code corresponds to a company; sending, by a communication device electrically connected to the reading device, the identification code to a cloud host; searching, by the cloud host, a database according to the identification code to update a stored record corresponding to the identification code; wherein the stored record comprises a read count of the identification code; when the read count is confirmed to be greater than or equal to two, sending, by the cloud host, an authorization signal to the communication device and registering a carbon credit feedback value of the company in the stored record, wherein the carbon credit feedback value is associated with a type of object.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a carbon credit registration system according to an embodiment of the present disclosure;

FIG. 2 is a flowchart of a carbon credit registration method according to an embodiment of the present disclosure;

FIG. 3 is a flowchart of updating a stored record according to an embodiment of the present disclosure;

FIG. 4 is a flowchart of updating the stored record according to another embodiment of the present disclosure;

FIG. 5 is a flowchart of updating the stored record according to yet another embodiment of the present disclosure;

FIG. 6 is a block diagram of a cleaning factory according to an embodiment of the present disclosure; and

FIG. 7 is a flowchart of a carbon credit registration method according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

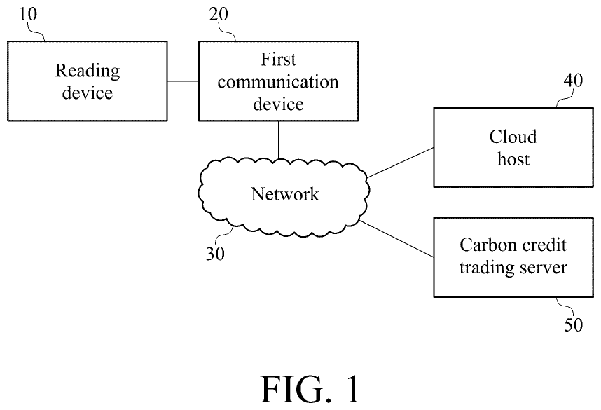

FIG. 1 is a block diagram of a carbon credit registration system according to an embodiment of the present disclosure. As shown in FIG. 1, a carbon credit registration system according to an embodiment of the present disclosure includes a reading device 10, a first communication device 20, and a cloud host 40. The reading device 10 is electrically connected to the first communication device 20, and the first communication device 20 is communicably connected to the cloud host 40 through a network 30. The cloud host 40 is communicably connected to a carbon credit trading server 50 through the network 30.

The reading device 10 is configured to read a first electronic tag disposed on an object to obtain a first identification code.

In an embodiment, the reading device 10 may be, for example, a radio-frequency identification (RFID) reader, a barcode scanner, or a camera device electrically connected to a microprocessor to decode the first electronic tag. The present disclosure does not limit the hardware configured to implement the reading device 10.

The object described in the present disclosure is reusable after processing. In an embodiment, the object may be a reusable cup, with the corresponding processing operation being cleaning. Subsequent descriptions and diagrams take “reusable cup” and “cleaning the reusable cup” as examples for explanation. However, the present disclosure does not limit the form of object and its processing. For example, in other application scenarios, the object may be a rechargeable battery, and the corresponding processing may be charging or discharging operations.

In an embodiment, the first electronic tag is a RFID tag. The first identification code included in the first electronic tag not only conforms to the GS1 code of the GS1 standard but also includes a body identification code representing the reusable cup itself. The GS1 code is configured to record information such as the manufacturer and the material composition of the reusable cup, so multiple reusable cups made by the same manufacturer have the same GS1 code. In this case, these reusable cups may be distinguished by the body identification code. In other words, the data composed of both the GS1 code and the body identification code is unique and may represent different reusable cups.

In an embodiment, the first identification code adopts a Unique Device Identification (UDI) code. The UDI code includes a Device Identifier (DI) and a Production Identifier (PI). DI is configured to identify the category of the object and has global uniqueness. PI is configured to identify production information of the object, such as manufacturing date, expiration date, batch number, and serial number. After the UDI coding is completed, GS1-128, GS1-Data Matrix, or GS1 Digital Link data carriers may be selected. The barcode software converts the code into a one-dimensional or two-dimensional barcode, corresponding to the GS1 standard coding method.

The following describes two embodiments of the integrated application of GS1 UDI and RFID tags.

In the first embodiment, the GS1 UDI code can be transcoded into an EPC code via a program and stored in the EPC Bank of a UHF Tag, with the TID Bank of the UHF Tag being an immutable unique chip code. By linking the GS1 UDI code with the EPC code and TID code in the RFID tag, a unique identifier for each item may be obtained.

In the second embodiment, the GS1 UDI code may be written into the User Bank of an HF Tag. The UID Bank of the HF Tag is an immutable unique chip code. By linking the GS1 UDI code with the UID code in the RFID tag, a unique identifier for each item may be obtained.

The first communication device 20 is electrically connected to the reading device 10. The first communication device 20 is configured to send the first identification code and receive an authorization signal sent by the cloud host 40.

In an embodiment, the first communication device 20 may be, for example, a communication chip, a network card, or any hardware device that complies with wired or wireless communication standards. The present disclosure does not limit the communication protocol adopt by the first communication device 20 nor the hardware of the first communication device 20.

Taking a reusable cup used in convenience stores as an example, a store clerk operates a beverage machine to fill the reusable cup with a beverage. The first electronic tag is disposed, for example, at the bottom of the reusable cup, and the reading device 10 is placed below the position where the reusable cup is placed on the beverage machine. The first communication device 20 may be built into the beverage machine or independent of it and is communicably connected to the remote cloud host 40 through a wired or wireless network, thereby sending and receiving the first identification code and the authorization signal.

The cloud host 40 is configured to search the database according to the first identification code to obtain a stored record corresponding to the first identification code. When it is confirmed that the stored record has a cleaning proof, the cloud host 40 sends an authorization signal to the first communication device 20, sets a used mark on the stored record in the database, and registers carbon credit feedback value of the company in the stored record. The stored record not only records the cleaning proof of the object but also records the carbon credit feedback value. The carbon credit feedback value is associated with a type of the object. For example, the carbon credit feedback value for a larger reusable cup is greater than that for a smaller reusable cup.

In an embodiment, the cloud host 40 is further configured to transmit information such as all stored records with their carbon credit feedback values and their corresponding companies to the carbon credit trading server 50 at a specified time, thereby allowing the manufacturer of the reusable cups to receive carbon credit feedback.

In an embodiment, the cloud host 40 may be a network server, a personal computer, a cloud virtual host, a cloud virtual platform, or a software program running on the aforementioned hardware devices. The present disclosure does not limit thereof.

In an embodiment, the database includes a plurality of stored records, with each stored record corresponding to a reusable cup. In other words, the database records the status of the plurality of reusable cups in a tabular form. Each stored record indicates whether the reusable cup has been cleaned, whether the reusable cup has been used, whether the reusable cup is to be cleaned, and the carbon credit feedback value that can be feedback by using this reusable cup, as shown in Table 1 below:

Table 1, an example of the stored record.

| First | | | | |
|---|---|---|---|---|
| Identification | | | | Carbon Credit |
| Code | Cleaning Proof | Used | To-be-cleaned | feedback value |
| A01 | Yes | Yes | No | 20 grams |
| A02 | Yes | No | No | 30 grams |
| A02 | No | Yes | Yes | 40 grams |
| A03 | No | No | Yes | 50 grams |

For example, if the first identification code queried by the cloud host 40 this time is A02, the cleaning proof field in its stored record is registered as “yes”, and the used field is registered as “no”.

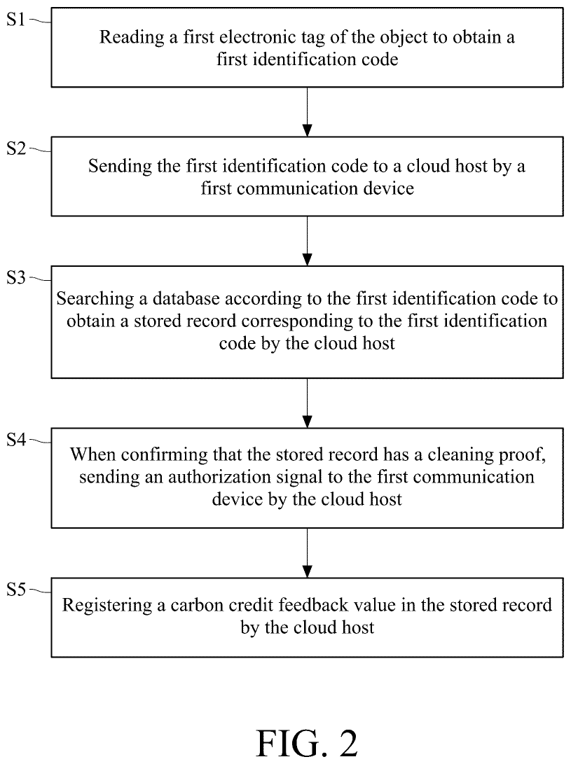

The process of the cloud host 40 sending the authorization signal is explained below through FIG. 2. FIG. 2 is a flowchart of a carbon credit registration method according to an embodiment of the present disclosure, with the application scenario being: a store clerk operating a beverage machine to fill a reusable cup with a drink for a consumer.

In step S1, the reading device 10 reads the first electronic tag disposed on the object to obtain the first identification code. In other words, the store clerk takes out a reusable cup and places it on the beverage machine. The bottom of the reusable cup is equipped with an RFID tag, and the built-in RFID reader of the machine reads this tag, thereby obtaining the GS1 code and the unique identification code of the reusable cup.

In step S2, the first communication device 20 electrically connected to the reading device 10 sends the first identification code to the cloud host 40.

In step S3, the cloud host 40 searches the database according to the first identification code to obtain the stored record corresponding to the first identification code. Refer to Table 1 for the example of the stored record.

In step S4, upon confirming that the stored record has a cleaning proof, the cloud host 40 sends an authorization signal to the first communication device 20 and sets a used mark of the stored record in the database. For example, in Table 1, if the cloud host 40 queries the stored record of the reusable cup with the first identification code A02 in step S3 and confirms that the cleaning proof field is registered as “yes”, the cloud host 40 sends the authorization signal. Additionally, the used field corresponding to the first identification code A02 is updated from “no” to “yes”.

In step S5, the cloud host 40 registers the carbon credit feedback value of the company in the stored record, wherein the carbon credit feedback value is associated with the type of the object.

In another embodiment, besides confirming that the stored record has a cleaning proof, it is also necessary to confirm that the reusable cup is being used for the first time (the used field is registered as “no”). The cloud host 40 may send the authorization signal only after these two conditions are satisfied.

When the first communication device 20 receives the authorization signal, it indicates that the reusable cup has been cleaned and has not been used. At this point, the beverage machine can fill the reusable cup with the drink, and then the store clerk hands the reusable cup to the user.

In an embodiment, after sending the authorization signal, the cloud host 40 immediately reports the first identification code and the corresponding carbon credit feedback value in the stored record to the carbon credit trading server 50. Alternatively, after sending the authorization signal N times, the cloud host 40 reports a plurality of first identification codes and a plurality of carbon credit feedback values corresponding to these N authorization signals together to the carbon credit trading server 50. Since the first identification code includes the GS1 code, the carbon credit trading server 50 may determine which manufacturer of the reusable cup should receive the carbon credit feedback value.

In the above embodiment, the cloud host 40 directly reports the original carbon credit feedback values and the first identification codes to the carbon credit trading server 50. In another embodiment, the cloud host 40 may identify the manufacturer of the reusable cups from the GS1 code included in the first identification code. After summing all the carbon credit feedback values, the cloud host 40 reports the manufacturer name (or code) and the sum of the carbon credit feedback values to the carbon credit trading server 50.

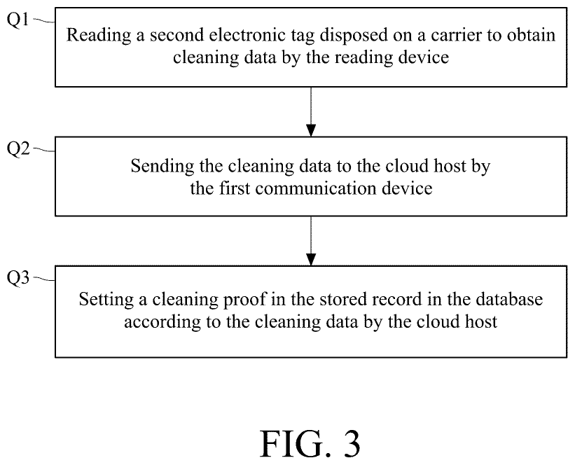

FIG. 3 is a flowchart of updating a stored record according to an embodiment of the present disclosure. The application scenario is that a plurality of cleaned reusable cups are packaged into a box and sent to a convenience store, where the store clerk registers the cleaning proof of these reusable cups. In other words, the process shown in FIG. 3 occurs before step S1 “reading the first electronic tag disposed on the object to obtain the first identification code by the reading device 10”.

In step Q1, the reading device 10 reads the second electronic tag disposed on the carrier to obtain the cleaning data, where the carrier is configured to carry the object, and the cleaning data includes the first identification code.

In an embodiment, the carrier is a cardboard box configured to be placed with the plurality of cleaned reusable cups, but the present disclosure is not limited by this example. The second electronic tag is disposed on an outside of the cardboard box and is configured to record the cleaning data of the reusable cups inside the box, such as the first identification code of each reusable cup, cleaning time, name of the cleaning factory, etc.

In step Q2, the first communication device 20 sends the cleaning data to the cloud host 40. In step Q3, the cloud host 40 sets the cleaning proof in the stored record in the database according to the cleaning data.

Practically, the store clerk scans the RFID tag on the outside of the cardboard box by the RFID reader, then the first communication device 20 uploads the cleaning data recorded in the RFID tag to the cloud host 40. Subsequently, the cloud host 40 may register the cleaning proof of these reusable cups in the cloud host 40 according to the first identification codes included in the cleaning data.

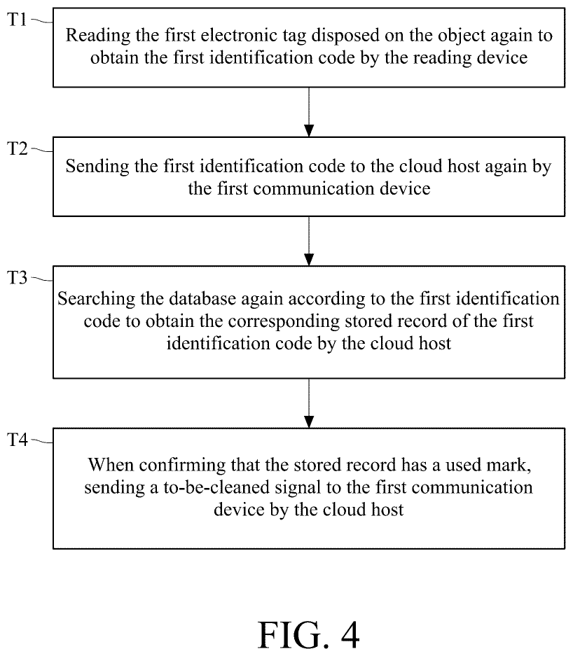

FIG. 4 is a flowchart of updating the stored record according to an embodiment of the present disclosure. The application scenario is that a consumer returns a used reusable cup to a convenience store, and the store clerk updates the usage record of this reusable cup. In other words, the process shown in FIG. 4 occurs after step S4 “sending an authorization signal to the first communication device 20 by the cloud host 40”.

In step T1, the reading device 10 reads the first electronic tag disposed on the object again to obtain the first identification code. In step T2, the first communication device 20 sends the first identification code to the cloud host 40 again. In step T3, the cloud host 40 searches the database again according to the first identification code to obtain the corresponding stored record of the first identification code. In step T4, when it is confirmed that the stored record has a used mark, the cloud host 40 sends a to-be-cleaned signal to the first communication device 20.

In the above process, the store clerk uses an RFID reader to scan the first electronic tag on the reusable cup, thereby reporting it to the cloud host 40. Since this reusable cup has been used, the cloud host 40 has the used field recorded as “yes” for this reusable cup. At this time, the cloud host 40 may set the to-be-cleaned field of this reusable cup to “yes” and send a to-be-cleaned signal to the beverage machine. Therefore, if the beverage machine receives the to-be-cleaned signal from the cloud host 40, it will not inject the beverage into the reusable cup, thereby preventing the user from reusing the reusable cup.

In an embodiment, the cloud host 40 may report the carbon credit feedback value in the stored record corresponding to the first identification code to the carbon trading server 50 immediately after sending the to-be-cleaned signal.

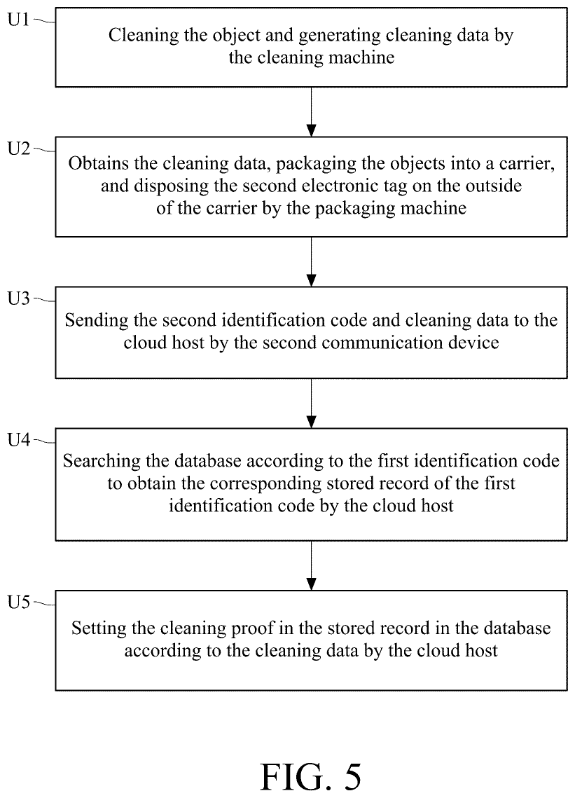

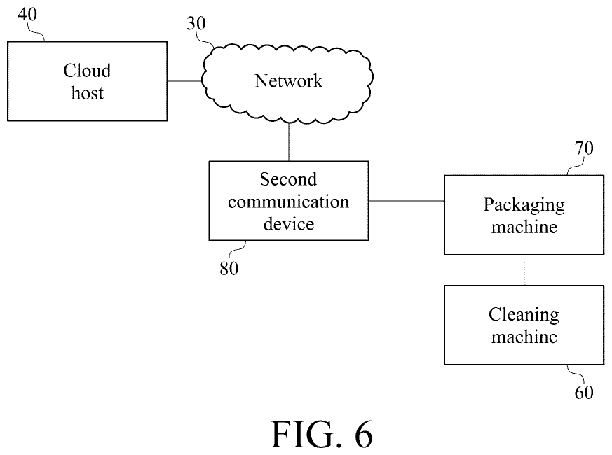

FIG. 5 is a flowchart of updating the stored record according to an embodiment of the present disclosure. The application scenario is that a convenience store collects a plurality of used reusable cups and sends them to a cleaning factory for cleaning, where the cleaning factory updates the cleaning data of these reusable cups. In other words, the process shown in FIG. 5 occurs after step T4 “sending a to-be-cleaned signal to the first communication device 20 by the cloud host 40”. The cleaning factory side includes a cleaning machine 60, a packaging machine 70, and a second communication device 80. The packaging machine 70 is electrically connected to the second communication device 80. The cleaning machine 60 is communicably connected to the cloud host 40 and the second communication device 80. The packaging machine 70 is communicably connected to the cloud host 40 through the second communication device 80. FIG. 6 is a block diagram of the cleaning factory according to an embodiment of the present disclosure.

In step U1, the cleaning machine 60 cleans the object and generates cleaning data, where the cleaning data includes the first identification code of the object. In other words, each time the cleaning machine 60 cleans a reusable cup, it generates a piece of cleaning data, which includes not only the first identification code of the cleaned reusable cup but also the cleaning operations the cup has undergone, such as dynamic immersion pre-soaking, high-temperature cleaning and sterilization, full-cup air knife drying, and quality inspection controlling.

After the cleaning machine 60 completes the cleaning, in step U2, the packaging machine 70 obtains the cleaning data, packages the objects into the carrier, and disposes the second electronic tag on the outside of the carrier. Practically, the packaging machine 70 seals a plurality of reusable cups into a cardboard box and establishes a second electronic tag on the outside of the cardboard box, the second electronic tag includes an identification code representing the cardboard box.

In step U3, the second communication device 80 sends the second identification code and cleaning data to the cloud host 40. In step U4, the cloud host 40 searches the database according to the first identification code to obtain the corresponding stored record of the first identification code. In step U5, the cloud host 40 sets the cleaning proof in the stored records in the database according to the cleaning data.

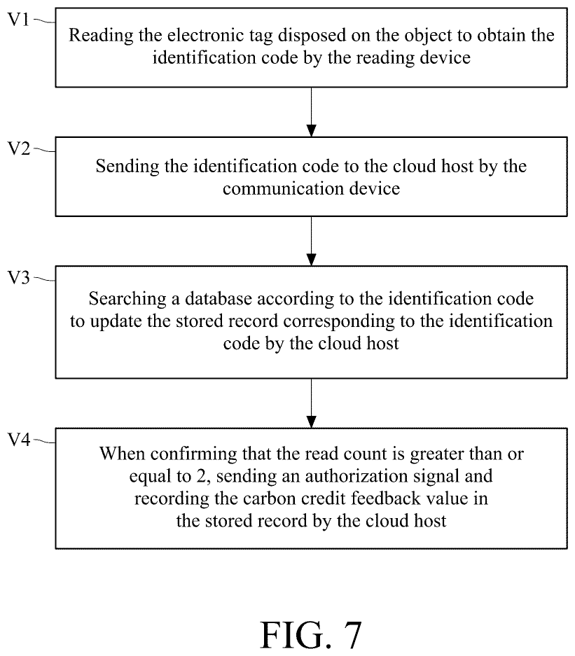

FIG. 7 is a flowchart of the carbon credit registration method according to another embodiment of the present disclosure, including steps V1 to V4.

In step V1, the reading device reads the electronic tag disposed on the object to obtain the identification code, where the identification code corresponds to the company. In step V2, the communication device electrically connected to the reading device sends the identification code to the cloud host.

In step V3, the cloud host searches a database according to the identification code to update the stored record corresponding to the identification code, where the stored record includes a read count of the identification code. In an embodiment, the default value of the read count is 0. Each time the cloud host receives the identification code of an object, it increments the read count in the stored record corresponding to that identification code by 1.

In step V4, when it is confirmed that the read count is greater than or equal to 2, the cloud host sends an authorization signal to the communication device and records the carbon credit feedback value of the company in the stored record, where the carbon credit feedback value is related to the type of the object. In other words, whenever the cloud host receives the identification code of an object for the second time (or more), it considers the object as recycled and records the carbon credit feedback value of the object for the company corresponding to the identification code.

In view of the above, the carbon credit registration system and method proposed by the present disclosure utilize a reading device to read the first electronic tag disposed on the object and the second electronic tag disposed on the carrier, and interact with the cloud host using the read information to confirm the processing status and usage status of the object. Additionally, the cloud host can report the collected carbon credit feedback values corresponding to the objects to the carbon trading server at an appropriate time. These carbon credit feedback values serve as the basis for the continued production of manufacturers that produce the objects. In other words, the carbon credit registration system and method proposed by the present disclosure essentially realize a carbon credit-based point of sale (POS) system. Any object that can be processed and reused is applicable to the carbon credit registration system and method proposed by the present disclosure, achieving convenient carbon credit feedback value statistics and quantifying the environmental protection effect.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. A carbon credit registration method, comprising:
reading, by a reading device, an electronic tag disposed on an object to obtain an identification code, wherein the identification code corresponds to a company;
sending, by a communication device electrically connected to the reading device, the identification code to a cloud host;
searching, by the cloud host, a database according to the identification code to obtain a stored record corresponding to the identification code;
sending, by the cloud host, an authorization signal to the communication device and setting a used mark on the stored record in the database when the stored record is confirmed to have a processing proof; and
registering, by the cloud host, a carbon credit feedback value of the company in the stored record, wherein the carbon credit feedback value is associated with a type of the object.

2. The carbon credit registration method of claim 1, wherein the electronic tag is a radio frequency identification tag, and the identification code comprises a GS1 code representing the company.

3. The carbon credit registration method of claim 1, wherein the electronic tag is a first electronic tag, and the method further comprises:
before reading the first electronic tag disposed on the object to obtain the identification code by the reading device, reading, by the reading device, a second electronic tag disposed on a carrier to obtain processed data, wherein the carrier is configured to carry the object, and the processed data comprises the identification code;
sending, by the communication device, the processed data to the cloud host; and
setting, by the cloud host, the processing proof in the stored record in the database according to the processed data.

4. The carbon credit registration method of claim 1, further comprising:
after sending the authorization signal to the communication device by the cloud host, reading, by the reading device, the electronic tag disposed on the object again to obtain the identification code;
sending, by the communication device, the identification code to the cloud host again;
searching, by the cloud host, the database according to the identification code again to obtain the stored record corresponding to the identification code; and
when the stored record is confirmed to have the used mark, sending, by the cloud host, a to-be-processed signal to the communication device.

5. The carbon credit registration method of claim 4, wherein the electronic tag is a first electronic tag, the identification code is a first identification code, the communication device is a first communication device, and the method further comprises:
after sending the to-be-processed signal to the communication device by the cloud host, performing a processing task on the object by a processing machine communicably connected to the cloud host and generating processing data, wherein the processing data comprises the first identification code;
after completing the processing task by the processing machine, obtaining the processing data by a packaging machine communicably connected to the processing machine;
packaging the object inside a carrier by the packaging machine and setting a second electronic tag on an outside of the carrier, wherein the second electronic tag comprises a second identification code representing the carrier;
sending, by a second communication device electrically connected to the packaging machine, the second identification code and the processing data to the cloud host;
searching, by the cloud host, the database according to the first identification code to obtain the stored record corresponding to the first identification code; and
setting, by the cloud host, the processing proof in the stored record in the database according to the processing data.

6. A carbon credit registration system, comprising:
a reading device configured to read an electronic tag disposed on an object to obtain an identification code, wherein the identification code corresponds to a company;
a communication device electrically connected to the reading device, wherein the communication device is configured to send the identification code and receive an authorization signal; and
a cloud host communicably connected to the communication device, wherein the cloud host is configured to search a database according to the identification code to obtain a stored record corresponding to the identification code, when the stored record is confirmed to have a processing proof, the cloud host is configured to send the authorization signal to the communication device, set a used mark on the stored record in the database, and register a carbon credit feedback value of the company in the stored record, wherein the carbon credit feedback value is associated with a type of object.

7. The carbon credit registration system of claim 6, wherein the electronic tag is a radio frequency identification tag, and the identification code comprises a GS1 code representing the company.

8. The carbon credit registration system of claim 6, wherein the electronic tag is a first electronic tag, the reading device is further configured to read a second electronic tag disposed on a carrier to obtain processed data, wherein the carrier is configured to carry the object, and the processed data comprises the identification code; the communication device is further configured to send the processed data to the cloud host; and the cloud host is further configured to set the processing proof in the stored record in the database according to the processed data.

9. The carbon credit registration system of claim 6, wherein after the cloud host sends the authorization signal to the communication device, the reading device is further configured to read the electronic tag disposed on the object again to obtain the identification code, the communication device is further configured to send the identification code to the cloud host again, the cloud host is further configured to search the database according to the identification code again to obtain the stored record corresponding to the identification code, and when the stored record is confirmed to have the used mark, the cloud host is further configured to send a to-be-processed signal to the communication device.

10. A carbon credit registration method, comprising:
reading, by a reading device, an electronic tag disposed on an object to obtain an identification code, wherein the identification code corresponds to a company;
sending, by a communication device electrically connected to the reading device, the identification code to a cloud host;
searching, by the cloud host, a database according to the identification code to update a stored record corresponding to the identification code, wherein the stored record comprises a read count of the identification code; and
when the read count is confirmed to be greater than or equal to two, sending, by the cloud host, an authorization signal to the communication device and registering a carbon credit feedback value of the company in the stored record, wherein the carbon credit feedback value is associated with a type of object.
